(19) United States
(12) Patent Application Publication
(10) Pub. No.: US 2008/0243927 A1
(43) Pub. Date: Oct. 2, 2008

(54) METHOD AND A SYSTEM FOR MAINTAINING AN INTEGRITY OF A PRODUCT

(75) Inventor: Manfred Langen, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/744,626

(22) Filed: May 4, 2007

(30) Foreign Application Priority Data
Mar. 28, 2007 (EP) 07006431

(51) Int. Cl. G06F 17/30

(52) U.S. Cl. 707/104.1; 707/200

(57) ABSTRACT

A system for maintaining an integrity of a product of a predetermined product type comprising configurable product elements, wherein a product description data set which indicates an actual configuration of said product is checked by means of a semantic reference model of said product type as to whether a product component configured for a product element of said product is compatible.

### BACKGROUND OF THE INVENTION

This invention relates to a method and a system for maintaining an integrity of a product, e.g. a vehicle.

Complex products, such as apparatuses, consist of many product elements. For example trains, cars, stations of a mobile communication system or tools for a medical apparatus have many single parts or product elements. Each product element is realized during manufacturing of the product by a unique product component. In a conventional system, an integrity of a complex product is guaranteed by the manufacturer only after manufacturing. E.g. a car manufacturer guarantees the integrity of a manufactured car when the car is delivered to the client. Later the integrity of the car cannot be guaranteed any longer, in particular, when a product component is exchanged by another product component without documentation.

Accordingly, it is an object of the present invention to provide a method and a system for maintaining an integrity of a complex product of a predetermined product type at any time.

### SUMMARY OF THE INVENTION

The invention provides a method for maintaining the integrity of a product of a predetermined product type comprising configured product elements,

wherein a product description data set which indicates an actual configuration of the product is checked by means of a semantic reference model of said product type as to whether a product component configured for a product element of said product is compatible.

In an embodiment of the method according to the present invention, the product description data set comprises for each configurable product element a unique component identification of a product component configured for said product element.

In an embodiment of the method according to the present invention the product component is formed by a hardware product component or by a software product component.

In an embodiment of the method according to the present invention the product description data set is stored in a local memory of said product.

In an embodiment of the method according to the present invention, the product description data set is stored in a central memory of the product manufacturer or of a product supplier.

In an embodiment of the method according to the present invention the product comprises a unique product identifier.

In an embodiment of the method according to the present invention the product component identifier of a hardware component comprises a type identifier, a serial number as well as meta data of a product manufacturer or of a product supplier.

In an embodiment of the method according to the present invention the product component identifier of a software product component comprises a type identifier, a software version number as well as meta data of a product manufacturer or of a product supplier.

In an embodiment of the method according to the present invention the product description data set of the product is loaded by means of said unique product identifier of said product from a central memory.

In an embodiment of the method according to the present invention the semantic reference model is described by means of a web ontology language (OWL) or by a resource description framework language (RDF).

In an embodiment of the method according to the present invention the product description data set is compared regularly with the semantic reference model of the product type.

In an embodiment of the method according to the present invention the product components used in said product communicate via a local network of the product with a data processing unit of the product.

In an embodiment of the method according to the present invention the product component transmits the respective product identifier to the data processing unit of the product via said local network.

In an embodiment of the method according to the present invention the data processing unit of the product actualizes said product description data set of the product on the basis of the product component identifier received from said product component.

In an embodiment of the method according to the present invention the data processing unit of the product compares the updated product description data set with the semantic reference model of said product type.

In an embodiment of the method according to the present invention the data processing unit of the product communicates via an interface with a server which has access to a semantic reference model of said product type.

In an embodiment of the method according to the present invention the interface is formed by an air interface.

In an embodiment of the method according to the present invention the product is formed by a mobile or by an immobile apparatus.

In an embodiment of the method according to the present invention the mobile apparatus is formed by a vehicle.

In an embodiment of the method according to the present invention a driving condition of the vehicle is detected by sensors and it is determined on the basis of said product description data set of said vehicle, whether the configured product components of said vehicle are admissible for the driving condition of said vehicle.

In an embodiment of the method according to the present invention the semantic reference model of said product type is updated by a product manufacturer.

In an embodiment of the method according to the present invention the actual software version of a software product component is loaded by a data processing unit of said product from an update server to replace the actual software version by another software version of said software product component.

The invention further provides a system for maintaining an integrity of a product of a predetermined product type comprising configurable product elements, wherein a product description data set which indicates the actual configuration of said product is checked by means of a semantic reference model of said product type as to whether a product component configured for a product element of said product is compatible.

In an embodiment of the system according to the present invention the product comprises a memory for storing the product description data set associated with said product.

In an embodiment of the system according to the present invention the product comprises a data processing unit for comparing the product description data set with said semantic reference model of said product type.

In an embodiment of the system according to the present invention the product comprises an interface for outputting the product description data set of the product from a memory of said product or for inputting said semantic reference model of said product type from a memory of a server.

In an embodiment of the system according to the present invention the interface is an air interface.

In an embodiment of the system according to the present invention the product comprises a local network which connects said product processing unit of said product with at least one product component.

In an embodiment of the system according to the present invention the product is connected via the interface with a server which has access to the semantic reference model of said product type.

In an embodiment of the system according to the present invention the product is a mobile or an immobile apparatus.

In an embodiment of the system according to the present invention the mobile apparatus is formed by a vehicle.

In an embodiment of the system according to the present invention the vehicle is a motor vehicle, an airplane, a train or a ship.

The invention further provides a product of a predetermined product type comprising configurable product elements, wherein

the product description data set of said product which indicates an actual configuration of said product is checkable by means of a semantic reference model of said product type as to whether the product component configured for a product element of said product is compatible.

The system according to the present invention is used in one embodiment for maintenance of a product.

The system according to the present invention is used in another embodiment for performing an automatic software update of the product.

The system according to the present invention is used in a further embodiment for detection of an inadmissible configuration of a product.

### BRIEF DESCRIPTION OF THE FIGURES

FIG. 1 shows a possible embodiment of a system according to the present invention for maintaining an integrity of a product;

FIG. 2 shows an example of a product illustrating a functionality of the method and the system according to the present invention for maintaining an integrity of the product;

FIG. 3 shows an exemplary product description data set of the exemplary product shown in FIG. 2;

FIG. 4 shows a further exemplary product description data set after maintenance of the product shown in FIG. 2;

FIG. 5 shows an exemplary semantic reference model (SRM) for illustrating the method and the system according to the present invention for maintaining an integrity of a product as shown in FIG. 2; and

FIG. 6 shows a block diagram of a possible embodiment of a product according to an embodiment of the present invention;

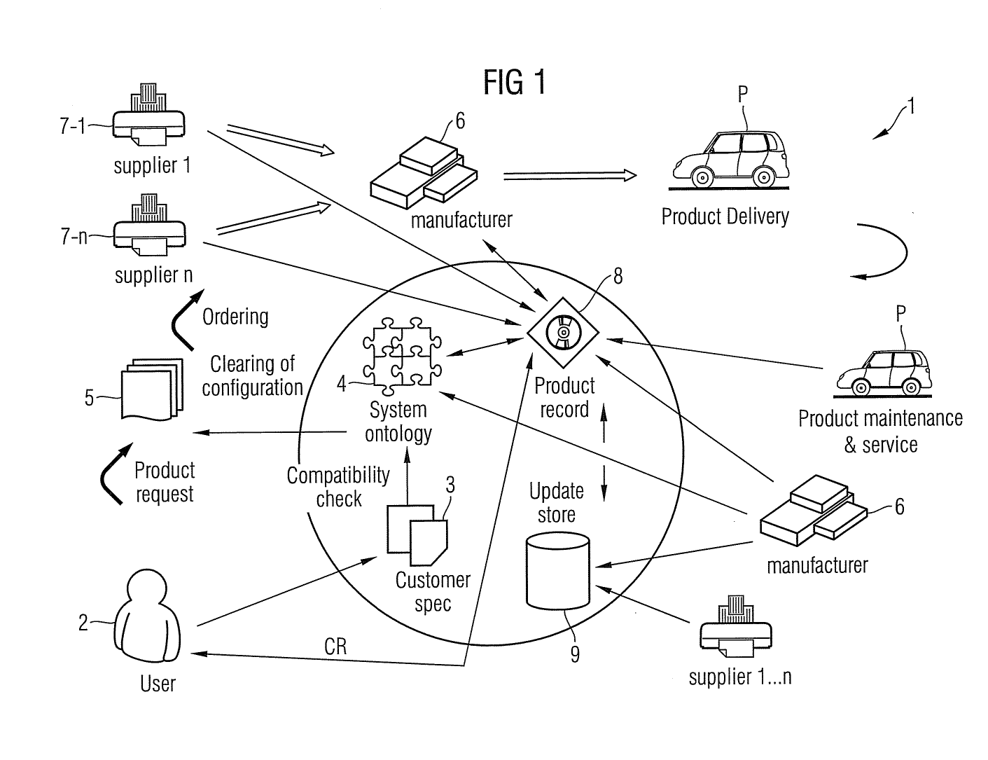

FIG. 1 is a diagram illustrating an embodiment of the system 1 according to the present invention for maintaining an integrity of a product P of a predetermined product type (P-Type). A client or user 2 describes a desired configuration of a product P such as a car by customer requirements CR which are stored in a customer's specification 3. The data content of the configuration, i.e., the customer's specification 3 is checked by means of a system ontology 4 of said product. Depending on the outcome of this initial compatibility check, i.e. configuration clearing, the desired configuration is ordered by means of an electronic order from a manufacturer 6 of said product. A new individual product instance of a product P is generated, and described in a product description data set PDDS. The manufacturer 6 and suppliers 7-1-7-n indicate in the product record or product description data set PDDS which product components PC are to be implemented for the ordered product P. The initial product description data set PDDS indicates the configuration of the ordered product P. The product description data set PDDS comprises for each configurable product element PE of the constructed product P as laid down in a construction plan of said product P a unique product component identification PC-ID of a product component PC configured for said product element PE. Product components PC are formed by hardware product components HW-PC or by software product components SW-PC. In a possible embodiment, the product description data set PDDS is stored in a local memory of said product P. Local memories can be built into said product forming itself product components PC of said product P. In the system 1 according to the present invention each product P comprises a unique product identifier P-ID. The manufacturer 6 and the suppliers 7 indicate in the product description data set PDDS of the product P which product component PC is to be implemented into the ordered product P. The product description data set PDDS comprises a type identifier and meta data for all product components P.

After manufacturing of the product P by the manufacturer 6 an initial version V1.0 of the product record or product description data set PDDS is generated. The product description data set PDDS describes which product components PC have been implemented for all product elements PE of the manufactured product P. This product record 8 is checked by means of a semantic reference model SRM of the respective product type P-TYPE of the product P as to whether all product components PC configured for the respective product elements PE of said product P are compatible with the semantic reference model SRM.

After this final compatibility check the manufactured product can be delivered by the manufacturer 6 to the client for example by a car-dealer.

With the system 1 as shown in FIG. 1, during the complete life cycle of the product P integrity checks can be performed regularly. In these integrity checks it is checked whether the individual product record PDDS which might have changed because of intended or unintended changes of the product P is still compatible with the system ontology of the product type, i.e., the semantic reference model SRM of the respective product type P-TYPE.

The manufacturer 6 of the product P can change the semantic reference model SRM during the life cycle of the product P for instance because of further technical insights. If a product component PC is exchanged for maintenance, the product description data set PDDS or product record 8 of the respective product P is updated. For each exchangeable product element PE a unique product component identifier PC-ID of the product component PC which is configured for said product element PE is provided. The product component identifier PC-ID of a hardware product component HW-PC such a valve or a circuit comprises a type identifier, a serial number as well as meta data of a product manufacturer or of a product supplier that manufactures or supplies the respective product components PC.

The product components PC can be either hardware product components HW-PC or software product components SW-PC. The product component identifier PC-ID of a software product component comprises a type identifier, a software version number as well as meta data of the manufacturer or of the product supplier which produces or which supplies the respective software product component SW-PC. In a possible embodiment a new software version can be loaded from the software manufacturer or software supplier from an update store 9 as shown in FIG. 1. During regular checks, new software versions can be loaded from the update store 9 leading to an update of the respective product description data set PDDS of the product P. In a possible embodiment, a communication facility is provided that allows the owner of the product P to receive messages about the system condition of the product P.

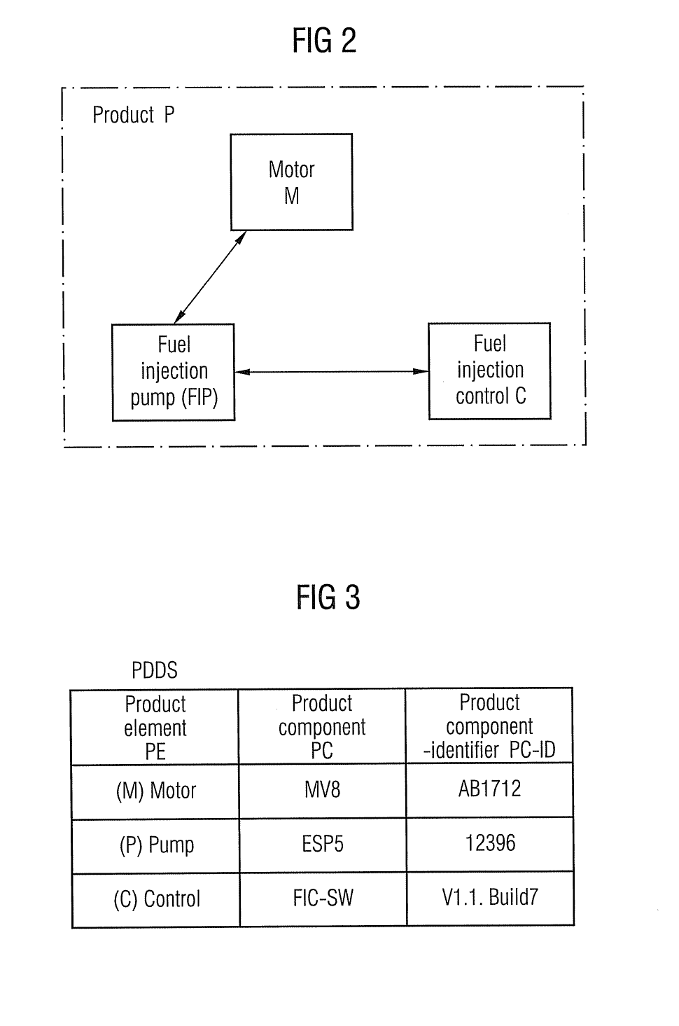

FIG. 2 shows a simple example of a product P of a predetermined product type P-TYPE such as a car of a predetermined product type such as VW Golf. In the exemplary example the product P comprises configurable product elements PE according to the construction plan of the product type P-TYPE. The product elements PE of the car comprise a motor M, a fuel injection pump FIP and a fuel injection control C.

FIG. 3 shows a product description data set PDDS that indicates an actual configuration of the product P of FIG. 2, e.g. after manufacturing of the product P. The product description data set as shown in FIG. 3 can be checked by means of the semantic reference model SRM of the product type P-TYPE as to whether the product components PC configured for the product elements PE of the product P are compatible or not. In the given example of FIG. 2 two of the implemented product components PC, i.e. MV8 for the motor M and ESP5 for the pump FIP are formed by hardware product components and one product component PC, i.e. FIC-SW is a software product component implementing the fuel injection control C. The product description data set PDDS as shown in FIG. 3 can be stored in a local memory of the product P, e.g. in a memory of a manufactured car. In an alternative embodiment, the product description data set PDDS as shown in FIG. 3 is stored in a central memory of the product manufacturer or of a product supplier, e.g. a car manufacturer or car-dealer, wherein each product P comprises a unique product identifier P-ID.

As can be seen from FIG. 3, the product component identifiers PC-ID of a unique implemented product component PC comprises e.g. a serial number such as “AB1712” for the product component “MV8”. In another embodiment, the product component identifier PC-ID can comprise a type identifier, a serial number as well as meta data of a manufacturer or of a supplier of the respective product component PC. As can be seen from FIG. 3, the product component identifier PC-ID of a software product component such as the control software comprises a software version no., i.e.

“V1.1 Build7”. The software product component identifier PC-ID can further comprise a type identifier as well as meta data of the manufacturer or of the supplier of the respective software SW.

In a possible embodiment the product description data set PDDS as shown in FIG. 3 of the product P is stored in a central memory of the manufacturer and can be loaded by means of a unique product identifier P-ID of the product P from said central memory.

In an alternative embodiment, the product description data set PDDS is stored in the respective product P itself. The product description data set PDDS as shown in FIG. 3 indicates an actual configuration of the product P. To maintain the integrity of the product P, the product description data set PDDS is checked by means of a semantic reference model SRM of the respective product type P-TYPE as to whether all product components PC such as MV8, ESP5 or FIC-SW configured for the respective product elements PE (M, FIP, C) of the product P are compatible with the semantic reference model SRM of the product type, e.g. the semantic reference model of a VW Golf.

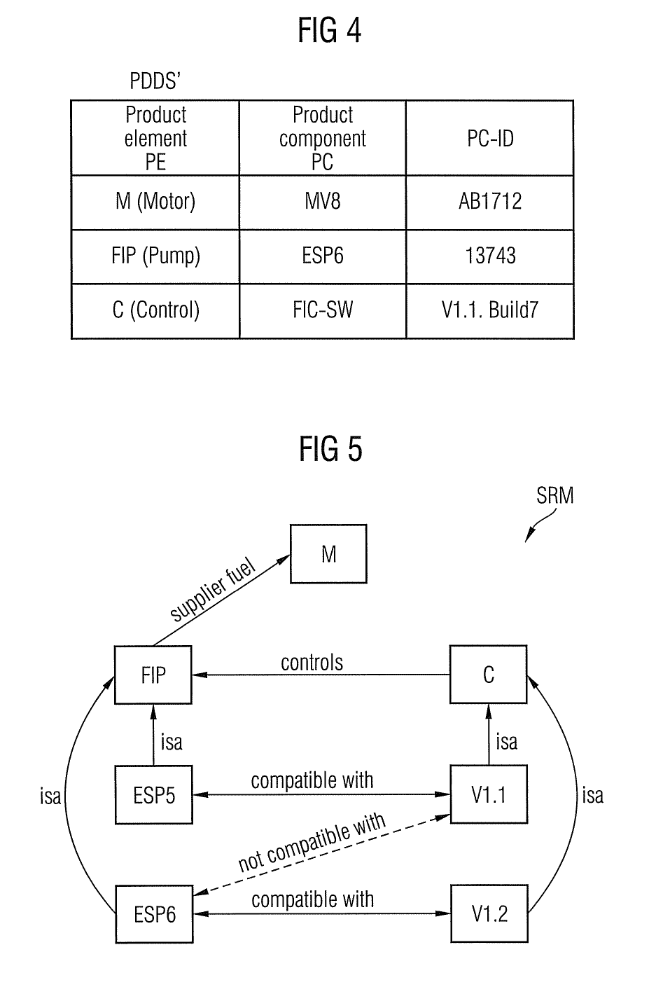

For example, if the fuel injection pump FIP of the vehicle shown in FIG. 2 is to be repaired, the product component ESP5 indicated in the product description data set PDDS shown in FIG. 3 can be replaced by another product component ESP6 indicated in the updated product description data set PDDS' as shown in FIG. 4.

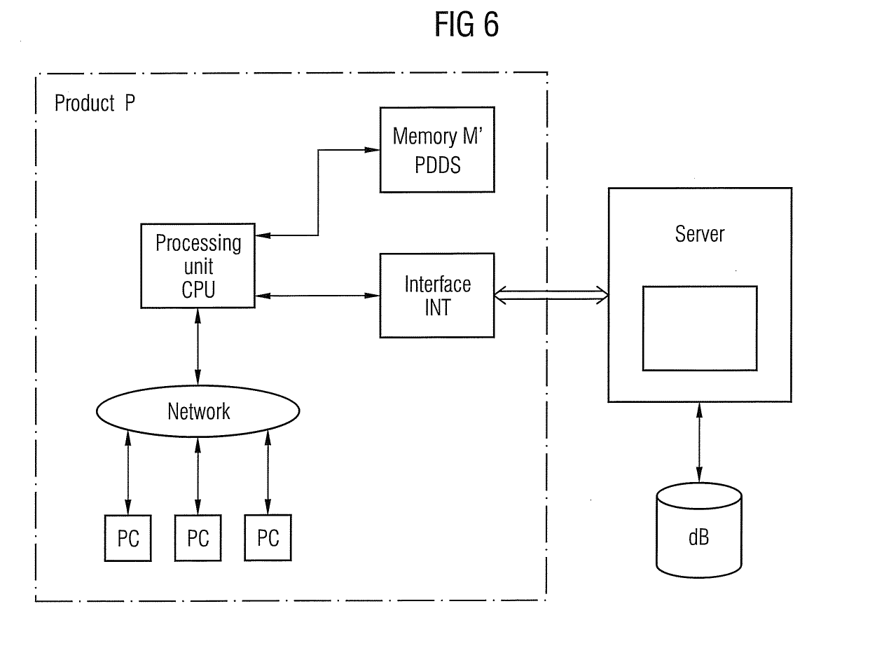

FIG. 5 shows an exemplary semantic reference model SRM of the respective product type P-TYPE which might be stored in a central memory or data base of the car manufacturer. The semantic reference model SRM can be described by means of a web ontology language OWL or e.g. by a resource description framework language RDF. The web ontology language OWL is a language for defining and instantiating a web ontology. OWL ontology language can include descriptions of classes, along with related properties and instances. The web ontology language OWL is designed to provide a way to process semantic content of information. The OWL-language is able to represent machine interpretable semantic content.

As can be seem in the example of FIG. 5, an product element PE formed by the fuel injection control C controls the fuel injection pump FIP which supplies fuel to the motor M. Two product components PC, i.e. ESP 5 and ESP6, form a fuel injection pump FIP. Likewise, both versions V1.1 and V1.2 form a fuel injection control software. As can be seen from FIG. 5, the semantic reference model SRM indicates that the software version 1.1 of the fuel injection control software is compatible with the product component ESP5 and that the other software version 1.2 of the fuel injection control software is compatible with a fuel injection pump ESP6. Furthermore, the semantic reference model SRM indicates that version 1.1 of the fuel injection control software is not compatible with a fuel injection pump ESP6. This information can for example already be known after construction of the product P. Further an incompatibility between specific software versions and specific kinds of injection pumps FIPs can be noted by users during the life cycle of the product P, for instance because of an increasing fuel consumption or even a complete failure of the product P. This information can be supplied by a user or by a repair service to the manufacturer. The manufacturer updates its semantic reference model SRM taking into account the given information. Accordingly, the semantic reference model SRM of the product type is in a possible embodiment non-static and can be updated. By checking the product description data set PDDS' as shown in FIG. 4 with the actual semantic reference model SRM shown in FIG. 5, it becomes evident that a product component PC, in this case ESP6 configured for a first product element PE, i.e. the fuel injection pump FIP, is not compatible with another product component PC, i.e. the fuel injection control software version 1.1 configured for a second product element, i.e. the fuel injection control C. The product description data set PDDS of a product P can be updated on a regular basis for a given semantic reference model SRM of the respective product type (P-TYPE).

FIG. 6 shows an embodiment of a complex product P according to an embodiment of the present invention. In this embodiment, the product P comprises a memory M storing a product description data set PDDS and a data processing unit CPU. The product P further comprises an interface INT for outputting the product description data set PDDS to a server or for inputting a semantic reference model SRM stored in a data base dB of the server. The data processing unit CPU within the product P can be connected in a possible embodiment via an internal network to a plurality of product components PC-1, PC-2 . . . PC-U. The interface INT as shown in FIG. 6 can be a wireless or a wired interface. The product P can be e.g. a manufactured car consisting of a plurality of product components PC such as a motor M, a fuel injection pump FIP or fuel injection control software.

In a possible embodiment, the data processing unit CPU of the product P such as a microprocessor compares the product description data set PDDS stored in the local memory M of the product P with the semantic reference model SRM of the respective product type P-TYPE stored in a data base dB of a car manufacturer.

In a possible embodiment, the data processing unit CPU of the product P requests the actual semantic reference model SRM of the respective product type P-TYPE and loads it via the interface INT from the server of the car manufacturer having access to the semantic reference model SRM stored in the data base dB of the manufacturer. Hence, the data processing unit CPU compares the actual reference model SRM with the actual product description data set PDS stored in local memory M of the product P as to whether the product components PC configured for the product elements PE of the product P are compatible or not.

In an alternative embodiment, the comparison is performed by the server, being formed for instance by a server of a car manufacturer or of a repair service. In this embodiment, the product description data set PDDS stored in the local memory M of the product P is read from the product P via the interface INT and the comparison is performed by a processing unit within the server. In a possible embodiment, at least a part of the product components PC implemented in the product P can communicate with the processing unit CPU via the local network. Each product component having a unique product component identifier PC-ID can supply the processing unit CPU with a type identifier, a serial number or a software version number as well as with meta data of the respective manufacturer supplier of the product component PC.

In a possible embodiment the product P is a mobile apparatus such as a vehicle. The vehicle can be any vehicle such as a car, a train, an airplane or a ship.

In a possible embodiment, the vehicle comprises sensors for detecting a driving condition of the vehicle. In this possible embodiment it is determined on the basis of the product description data set PDDS of the vehicle P whether the configured product components PC of the vehicle are admissible for the actual driving condition of the vehicle. For instance, it might be detected that a vehicle drives at a high speed, e.g. 200 km/h and has tires which are not admissible for this high speed. This can be indicated to the driver of the vehicle.

In a possible embodiment, the velocity of the vehicle is automatically reduced to the admissible velocity for the configured tires.

In a further example, a manufacturer can make use of the method and system 1 according to the present invention for finding out which product instances have been delivered with a specific configuration. For example when it has been found out that a combination of a specific brake unit (supplier X, charge Y) with a specific wheel suspension (supplier Z, type 33) is not safe then the system 1 allows to identify the specific products P and to identify the owners of the respective cars. The respective combination of the brake unit and the wheel suspense can be stored in the semantic reference model SRM as a relation “non-compatible”. From a specific condition, “if-relation between (braking unit, wheel suspense)is not compatible” a function (callback action (S)) can be derived wherein a specific kind of callback action for the cars as described in the callback function S is performed.

Further possible applications of the system 1 and method according to the present invention are automatic updates of software for instance in medical apparatuses. If there is provided a wireless connection between the product P and an update software store, a software update can be triggered automatically by the manufacturer.

Furthermore, the system 1 according to the present invention allows a continuously performed long distance maintenance of a product P via a wireless interface INT of the product P. If an operator of a product P performs an product component exchange which is not admissible by the manufacturer, this can also be detected.

Furthermore, a service notification after a predetermined driving distance can be sent from the manufacturer to the operator of the product.

The system 1 according to the present invention facilitates also statistical evaluations and a dynamical evaluation of operation data.

Furthermore, a semantic reference model SRM can also be modified by time dependencies, e.g. a product component PC can have a guaranteed life time for Z years. The life time can be measured as absolute time or as operation time of the product. After this time period the consistency or compatibility of the product P is no longer guaranteed.

1. A method for maintaining an integrity of a product of a predetermined product type having configurable product elements, comprising:
storing a product description data set which indicates an actual configuration of said product is checked by a semantic reference model of said product type as to whether a product component configured for a product element of said product is compatible.

2. The method according to claim 1, wherein the product description data set comprises for each configurable product element a unique product component identification of a product component configured for said product element.

3. The method according to claim 1, further comprising updating the semantic reference model of said product type by a product manufacturer.

4. The method according to claim 1, wherein the product description data set is stored in a local memory of said product.

5. The method according to claim 1, wherein the product description data set is stored in a central memory of the product manufacturer or of a product supplier.

6. The method according to claim 1, wherein the product has a unique product identifier.

7. The method according to claim 6, wherein the product description data set of said product is loaded by said unique product identifier, of said product from a central memory.

8. The method according to claim 1, wherein the semantic reference model is described by a web ontology language or by a resource description framework language.

9. The method according to claim 1, further comprising regularly comparing the product description data set with the semantic reference model of said product type.

10. The method according to claim 1, wherein the product components used in said product communicate via a local network of said product with a data processing unit of said product.

11. The method according to claim 10, wherein the product components transmit respective product component identifiers to said data processing unit of said product via said local network.

12. The method according to claim 11, wherein the data processing unit of said product actualizes said product description data set of said product based on the product component identifiers received from said product components.

13. The method according to claim 12, wherein the data processing unit of said product compares the updated product description data set with the semantic reference model of said product type.

14. The method according to claim 13, wherein the data processing unit of said product communicates via an interface with a server which has access to a semantic reference model of said product type.

15. The method according to claim 14, wherein the interface is formed by an air-interface.

16. The method according to claim 1, wherein the product is formed by a mobile or an immobile apparatus.

17. The method according to claim 16, wherein the mobile apparatus is formed by a vehicle.

18. The method according to claim 17, wherein a driving condition of the vehicle is detected by sensors and it is determined on the basis of said product description data set of said vehicle whether the configured product components of said vehicle are admissible for the driving condition of said vehicle.

19. The method according to claim 1, wherein each product component is a hardware product component or a software product component.

20. The method according to claim 19, wherein the product component identifier of a hardware product component comprises a type identifier, a serial number as well as metadata of a product manufacturer or a product supplier.

21. The method according to claim 19, wherein the product component identifier of a software product component comprises a type identifier, a software version number as well as metadata of a product manufacturer or a product supplier.

22. The method according to claim 19, wherein an actual software version of a software product component is loaded by a data processing unit of said product from an update server to replace the actual software version by another software version of said software product component.

23. A system for maintaining an integrity of a product of a predetermined product type having configurable product elements, comprising:
a storage unit storing a product description data set which indicates an actual configuration of said product is checked by a semantic reference model of the predetermined product type as to whether a product component configured for a product element of said product is compatible.

24. The system according to claim 23, wherein said product comprises a memory for storing the product description data set associated with said product.

25. The system according to claim 23, wherein said product comprises a data processing unit for comparing said product description data set with said semantic reference model of said product type.

26. The system according to claim 25, wherein the product comprises a local network which connects said data processing unit of said product with at least one product component.

27. The system according to claim 23, wherein said product comprises an interface for outputting the product description data set of said product from a memory of said product or for inputting said semantic reference model of said product type from a memory of a server.

28. The system according to claim 27, wherein the interface is a wireless interface.

29. The system according to claim 27, wherein the product is connected via said interface with a server which has access to said semantic reference model of said product type.

30. The system according to claim 23, wherein said product is a mobile or immobile apparatus.

31. The system according to claim 30, wherein the mobile apparatus is a vehicle.

32. The system according to claim 31, wherein said vehicle is a motor vehicle, an airplane, a train or a ship.

33. A method of maintaining a product comprising:
storing a product description data set of the product;
checking an actual configuration of the product by a semantic reference model of the predetermined product type to determine whether a product component configured for a product element of the product is compatible; and
changing at least one product component to maintain compatibility.

34. A method of performing automatic software updates of a product comprising:
storing a product description data set of the product;
checking an actual configuration of the product by a semantic reference model of the predetermined product type to determine whether a product component configured for a product element of the product is compatible; and
automatically updating software to maintain compatibility of product components of the product.

35. A method of detecting an inadmissible configuration of a product, comprising:
storing a product description data set of the product; and
checking an actual configuration of the product by a semantic reference model of the predetermined product type to determine whether a product component configured for a product element of the product is compatible.

36. A product of a predetermined product type comprising:
configurable product elements defined in a product description data set of said product which indicates an actual configuration of said product and is checkable by a semantic reference model of said product type as to whether a product component configured for a product element of said product is compatible.

37. The product according to claim 36, wherein the product is a mobile or immobile apparatus.

38. The product according to claim 37, wherein said mobile apparatus is a vehicle.

39. The product according to claim 38, wherein the vehicle is a motor vehicle, a train, an airplane or a ship.
